(19) United States
(12) Patent Application Publication
(10) Pub. No.: US 2026/0228520 A1
(43) Pub. Date: Aug. 6, 2026

(54) ATTENTION GENERATION DEVICE, ATTENTION GENERATION METHOD, AND RECORDING MEDIUM

(71) Applicant: NEC CORPORATION, Tokyo (JP)

(72) Inventors: Koji OKABE, Tokyo (JP); Tetsuya UEDA, Tokyo (JP)

(73) Assignee: NEC Corporation, Tokyo (JP)

(21) Appl. No.: 19/142,270

(22) PCT Filed: Nov. 2, 2023
(86) PCT No.: PCT/JP2023/039667

§ 371 Date: Jun. 23, 2025

(30) Foreign Application Priority Data
Jan. 6, 2023 (JP) 2023-001310

(51) Int. Cl. G06N 3/08

(52) U.S. Cl. CPC G06N 3/08

(57) ABSTRACT

Attention, which is a weight coefficient for each part of input data, is calculated for each part of output data for the generation of the part of output data. Furthermore, the device corrects an object attention, which is an attention for generating the part to be generated among the parts of the output data, on the basis of the attention for generating the part that has already been generated among the parts of the output data.

### TECHNICAL FIELD

The present disclosure relates to an attention generation device, an attention generation method, and a recording medium.

### BACKGROUND ART

In data processing, data to be processed may include a plurality of parts, and the plurality of parts may be weighted.

For example, in PTL 1, in a case where the feature value for each frequency domain of the speech frame is input to the speech recognition model, it is determined by the attention weighting value whether to view the feature value in any frequency domain more important among the feature values for each frequency domain of the speech frame.

### CITATION LIST

### Patent Literature

PTL 1: JP2018-109760 A

### SUMMARY OF INVENTION

### Technical Problem

In the data processing, in a case where the part of the data to be processed is weighted, repetition of the part of the data may be avoided or reduced in the data obtained by the data processing.

An object of the present disclosure is to provide an attention generation device, an attention generation method, and a recording medium that can solve the above problems.

### Solution to Problem

According to a first aspect of the present disclosure, an attention generation device includes an attention calculation means that calculates an attention, which is a weight coefficient for each part of input data, for generating a part of output data for each part of the output data; and an attention correction means that corrects an object attention, which is an attention for generating a part to be generated among the parts of the output data, based on an attention for generating a part that has already been generated among the parts of the output data.

According to a second aspect of the present disclosure, an attention generation method causes a computer to execute calculating an attention, which is a weight coefficient for each part of input data, for generating a part of output data for each part of the output data; and correcting an object attention, which is an attention for generating a part to be generated among the parts of the output data, based on an attention for generating a part that has already been generated among the parts of the output data.

According to a third aspect of the present disclosure, a recording medium stores a program for causing the computer to execute calculating an attention, which is a weight coefficient for each part of input data, for generating a part of output data for each part of the output data; and correcting an object attention, which is an attention for generating a part to be generated among the parts of the output data, based on an attention for generating a part that has already been generated among the parts of the output data.

### BRIEF DESCRIPTION OF DRAWINGS

FIG. 1 is a diagram illustrating an example of a configuration of an attention generation device according to some example embodiments of the present disclosure.

FIG. 2 is a diagram illustrating an example of an attention calculated by an attention calculation unit according to some example embodiments of the present disclosure.

FIG. 3 is a diagram illustrating an example of an attention correction by an attention correction unit according to some example embodiments of the present disclosure.

FIG. 4 is a diagram illustrating an example of a processing procedure in which an attention generation device according to some example embodiments of the present disclosure generates an attention.

FIG. 5 is a diagram illustrating an example of a processing procedure in which an attention generation device according to some example embodiments of the present disclosure updates a coverage set.

FIG. 6 is a diagram illustrating an example of a configuration of an attention generation device according to some example embodiments of the present disclosure.

FIG. 7 is a diagram illustrating an example of an attention correction by an attention correction unit according to some example embodiments of the present disclosure.

FIG. 8 is a diagram illustrating an example of a processing procedure in which an attention generation device according to some example embodiments of the present disclosure generates an attention.

FIG. 9 is a diagram illustrating an example of a configuration of a data generation device according to some example embodiments of the present disclosure.

FIG. 10 is a diagram illustrating an example of input and output of data in each unit of the data generation device according to some example embodiments of the present disclosure.

FIG. 11 is a diagram illustrating an example of a configuration of an attention generation device according to some example embodiments of the present disclosure.

FIG. 12 is a diagram illustrating an example of a processing procedure in an attention generation method according to some example embodiments of the present disclosure.

FIG. 13 is a schematic block diagram illustrating a configuration of a computer according to at least one example embodiment.

### EXAMPLE EMBODIMENT

Hereinafter, example embodiments of the present disclosure will be described, but the following example embodiments do not limit the invention according to the claims. Not all combinations of features described in the example embodiments are essential to the solution of the invention.

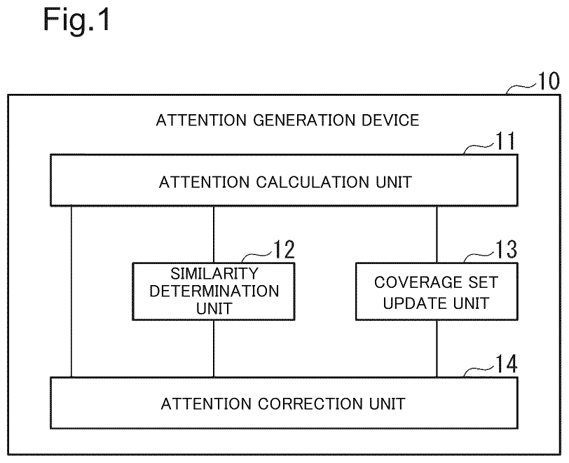

FIG. 1 is a diagram illustrating an example of a configuration of an attention generation device according to some example embodiments of the present disclosure. In the configuration illustrated in FIG. 1, an attention generation device 10 includes an attention calculation unit 11, a similarity determination unit 12, a coverage set update unit 13, and an attention correction unit 14.

The attention generation device 10 generates an attention. The attention referred to herein is a weight coefficient indicating a weight for each part of the input data when a certain part of the output data is generated in the processing of generating the output data that can be divided into parts based on the input data that can be divided into parts. The weight coefficient for each part of the input data indicated by the attention is also referred to as an element of the attention.

The attention can be regarded as data indicating which part of the input data should be paid attention to and how much attention should be paid when a certain part of the output data is generated.

The input data and the output data for which the attention generation device 10 generates an attention are not limited to a specific type of data. The unit of division of the input data and the unit of division of the output data are not limited to specific units.

For example, in a case where the attention generation device 10 is used for attention generation of the voice recognition device, the input data may be voice data, and the output data may be data of a character string in which the voice of the voice data is converted into a character. In this case, the part obtained by dividing the input data may be each part obtained by dividing the voice data as the input data for each predetermined time length. The part obtained by dividing the output data may be each character included in the character string, each word, or each segment.

Alternatively, in a case where the attention generation device 10 is used to generate an attention of the machine translation device from a document to a document, the input data may be data of a character string indicating the document to be translated, and the output data may be data of a character string indicating the document of the translation result. In this case, the part obtained by dividing the input data may be each character included in the character string, each word, or each segment. A part obtained by dividing the output data may also be each character included in the character string, each word, or each segment. The unit of division may be the same or different between the input data and the output data.

Alternatively, in a case where the attention generation device 10 detects a character string included in an image and is used for attention generation of a character recognition device that recognizes the character string, the input data may be image data, and the output data may be data indicating a character string detected and recognized from the image. In this case, the part obtained by dividing the input data may be each part obtained by dividing the input data for each predetermined pixel in the vertical direction and the horizontal direction. The divided part of the output data may be data that is detected from the divided part of the input image and indicates a recognized character string.

Alternatively, in a case where the attention generation device 10 is used for attention generation of an image recognition device that performs object recognition for detecting an object appearing in an image, the input data may be image data. In this case, the output data may be data of a character string including an explanatory sentence of the object recognition result. In this case, the part obtained by dividing the input data may be each part obtained by dividing the input data for each predetermined pixel in the vertical direction and the horizontal direction. The part obtained by dividing the output data may be data of a character string including an explanatory sentence of the object recognition result for the part obtained by dividing the input image.

The input data and the output data here are not necessarily required to be input data and output data to the attention generation device 10. The input data and the output data mentioned here are, for example, input data and output data to a data generation device that generates output data based on the input data, such as the voice recognition device, the machine translation device, the character recognition device, or the image recognition device.

The data generation device that generates output data based on input data is also simply referred to as a data generation device.

The input data to the attention generation device 10 may be data obtained by applying processing to each part of the input data to the input data to the data generation device. For example, the input data to the attention generation device 10 may be data indicating a feature amount extracted by the data generation device for each part of the input data to the data generation device. The output data from the attention generation device 10 may be an attention generated by the attention generation device 10.

The attention generation device 10 may be configured using, for example, a personal computer (PC) or a workstation (WS). Alternatively, the attention generation device 10 may be configured using dedicated hardware such as an application specific integrated circuit (ASIC) or a field programmable gate array (FPGA).

The attention calculation unit 11 calculates the attention for each part of the output data for generating the part of the output data. As described above, the attention is a weight coefficient for each part of the input data.

The attention calculation unit 11 is relevant to an example of an attention calculation means.

The method by which the attention calculation unit 11 calculates the attention is not limited to a specific method. For example, the attention calculation unit 11 may be configured using a known attention mechanism, or the attention calculation unit 11 may calculate an attention using a known attention calculation algorithm.

The similarity determination unit 12 calculates the similarity between each of the generated attention for generating the part of the output data and the object attention. The object attention here is an attention for generating a part to be generated (a part to be generated next) among the parts of the output data. The attention for generating the part that has already been generated among the parts of the output data is the attention generated by the attention generation device 10 before generation of the object attention.

Based on the calculated similarity, the similarity determination unit 12 determines the presence or absence of an attention similar to the object attention among the attentions for generating the part that has already been generated among the parts of the output data.

The similarity determination unit 12 is relevant to an example of a similarity determination means.

The similarity of the attention calculated by the similarity determination unit 12 is not limited to a specific type of similarity. For example, the attention can be expressed by a vector, and as the similarity of the attention calculated by the similarity determination unit 12, various similarities applicable to the similarity between two vectors, such as a correlation coefficient or a cosine similarity, can be used.

The coverage set update unit 13 updates the coverage set each time the attention calculation unit 11 calculates a symmetric attention. The coverage set referred to herein is a set having an index for identifying a part of the input data as an element, and indicates a part of the input data that has been weighted more than a predetermined condition. The coverage set can be regarded as a set indicating a part that has attracted attention among the parts of the input data.

The coverage set update unit 13 adds, as an element of the coverage set, an index for identifying the input part data to which the weight coefficient determined to be larger than or equal to a predetermined condition among the weight coefficients included in the object attention is applied.

The coverage set update unit 13 is relevant to an example of a coverage set update means.

The attention correction unit 14 corrects the object attention based on the attention for generating the part that has already been generated among the parts of the output data. The attention correction unit 14 is relevant to an example of an attention correction means.

Specifically, the attention correction unit 14 rewrites the value of the weight coefficient associated with the index indicated in the coverage set before the information regarding the object attention is reflected among the weight coefficients included in the object attention to 0 or a value determined in advance as a sufficiently small positive value.

The correction of the object attention performed by the attention correction unit 14 can be regarded as processing of rewriting the value of the weight coefficient attached to the input part data that has attracted attention among the weight coefficients included in the object attention so as to lower the attention degree. When the attention correction unit 14 corrects the object attention, it is expected that the data generation device can avoid or reduce erroneous processing in which the data generation device repeatedly focuses on the same portion of the part of the input data and repeatedly generates the same portion data as the part of the output data.

In a case where the similarity determination unit 12 determines that there is an attention similar to the object attention among the attentions for generating the part that has already been generated among the parts of the output data, the attention correction unit 14 corrects the object attention based on the attention for generating the part that has already been generated among the parts of the output data.

Then, the attention correction unit 14 multiplies each element of the object attention by a coefficient so that the sum of each element of the object attention becomes 1. Multiplying each element of the attention by a coefficient so that the sum of each element of the attention is 1 is also referred to as normalization for setting the sum of each element of the attention to 1.

The attention correction unit 14 calculates the sum of the elements of the object attention corrected based on the coverage set. Then, the attention correction unit 14 calculates the reciprocal of the calculated sum as a coefficient for setting the sum of each element of the object attention to 1. The attention correction unit 14 multiplies each element of the object attention after the element is rewritten based on the coverage set by the calculated coefficient to generate the corrected object attention.

The attention correction unit 14 generates an object attention for updating the coverage set.

In the generation of the object attention for the coverage set update, the attention correction unit 14 detects the largest element among the elements of the object attention after correction.

Then, the attention correction unit 14 calculates the reciprocal of the detected maximum element as a coefficient for generating the object attention for the coverage set update. That is, the attention correction unit 14 calculates a coefficient with which the maximum value of the attention element becomes 1 as a coefficient for generating the object attention for the coverage set update.

The attention correction unit 14 multiplies each element of the corrected object attention by the calculated coefficient to generate the object attention for the coverage set update. Multiplying each element of the attention by a coefficient such that the maximum value of the element of the attention becomes 1 is also referred to as normalization for updating the coverage set.

The coverage set update unit 13 adds, as an element of the coverage set, an index for identifying the input part data to which the element determined to be greater than or equal to a predetermined condition among the elements of the object attention for the coverage set update is applied.

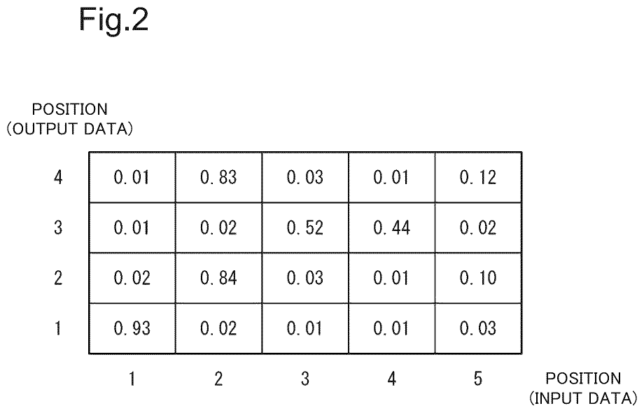

FIG. 2 is a diagram illustrating an example of an attention calculated by the attention calculation unit 11.

In FIG. 2, the attention calculated by the attention calculation unit 11 is illustrated in a table format, and each column is associated with a position in the input data and each row is associated with a position in the output data. The position here is relevant to an example of an index for identifying a part of data.

In the example of FIG. 2, it is assumed that the attention calculation unit 11 calculates the attention for each row in the order of positions 1, 2, 3, and 4 of the output data.

The attention calculation unit 11 calculates an attention such that the sum of the elements of the attention for one row becomes 1 with the significant digits up to the second decimal place.

However, the attention calculated by the attention calculation unit 11 is not limited to a specific attention. The attention calculated by the attention calculation unit 11 is calculated for each part of the output data, and can be various types indicating a weight coefficient for each part of the input data.

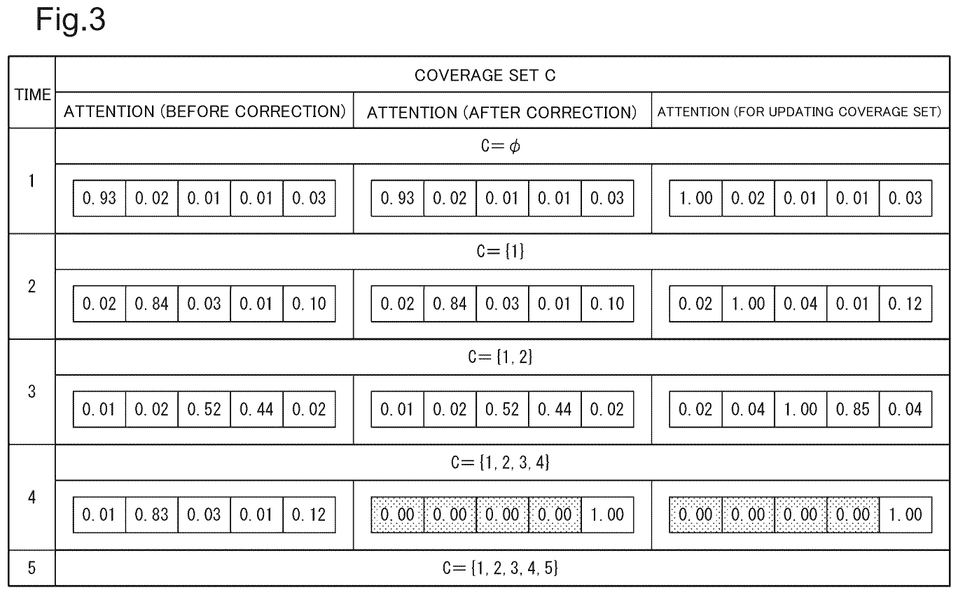

FIG. 3 is a diagram illustrating an example of attention correction by the attention correction unit 14. FIG. 3 illustrates an example of a case where the attention correction unit 14 corrects the attention in the example of FIG. 2.

FIG. 3 illustrates, for each time step, the coverage set before update in the time step, the object attention before correction by the attention correction unit 14, the object attention after correction by the attention correction unit 14, and the object attention for updating the coverage set.

In FIG. 3, the time for the attention generation device 10 to generate the object attention for generating one piece of output part data is set as one step of the time step. The object attention before correction is the object attention calculated by the attention calculation unit 11, and the attention of the positions 1, 2, 3, and 4 of the output data in the example of FIG. 2 is illustrated in the order of time steps 1, 2, 3, and 4.

FIG. 3 illustrates an example of a case where the data generation device ends the generation of the output data after generating the part of the output data in the time step 4. Therefore, in the time step 5, the attention generation device 10 does not generate an attention.

As described above, the coverage set indicates a part to which a large weight greater than or equal to a predetermined condition has been applied among the parts of the input data. Here, the coverage set is represented by “C”. An initial value of the coverage set C is set to the empty set o.

In the correction of the object attention, the similarity determination unit 12 determines the presence or absence of an attention similar to the object attention among the attentions for generating the part that has already been generated among the parts of the output data.

The similarity determination unit 12 may compare the object attention with the attention after the attention correction unit 14 corrects the attention calculated before the attention calculation unit 11 calculates the object attention. Alternatively, the similarity determination unit 12 may compare the object attention with the attention (attention before correction by the attention correction unit 14) calculated by the attention calculation unit 11 before the calculation of the object attention.

In the example of FIG. 3, the similarity determination unit 12 compares the object attention with the attention after the attention correction unit 14 corrects the attention calculated before the calculation of the object attention by the attention calculation unit 11. In a case where the correlation coefficient of the two attentions is larger than a threshold t_{corr}, the similarity determination unit 12 determines that the two attentions are similar to each other, and sets the value of the threshold t_{corr} to 0.8.

The attention correction unit 14 corrects the object attention in a case where the similarity determination unit 12 determines that there is an attention similar to the object attention among the attentions for generating the part that has already been generated among the parts of the output data. The attention correction unit 14 rewrites the value of the element associated with the index indicated in the coverage set before the information regarding the object attention is reflected among the elements (weight coefficients) of the object attention to 0 or a value determined in advance as a sufficiently small positive value.

In the time step 1, no attention has been generated by the attention generation device 10 before generation of the object attention. Therefore, the similarity determination unit 12 determines that there is no attention similar to the object attention among the attentions for generating the part that has already been generated among the parts of the output data.

In this case, the attention correction unit 14 does not correct the object attention, and adopts the object attention calculated by the attention calculation unit 11 as it is as the corrected object attention. The attention generation device 10 outputs the object attention calculated by the attention calculation unit 11 as it is as the attention for generating the part of the output data by the data generation device.

The attention correction unit 14 further generates an object attention for updating the coverage set. The attention correction unit 14 detects the largest element among the elements (weight coefficients) of the object attention after correction. Then, the attention correction unit 14 calculates a coefficient such that the value of the detected largest element becomes 1, and multiplies each element of the corrected object attention by the calculated coefficient. Alternatively, instead of the attention correction unit 14, the coverage set update unit 13 may generate the object attention for the coverage set update.

In the time step 1, the maximum value of the element of corrected the object attention is 0.93. Therefore, the attention correction unit 14 calculates the coefficient for generating the object attention for the coverage set update as 1/0.93=1.08. The attention correction unit 14 multiplies each element of the corrected object attention by the calculated coefficient 1.08 to generate the object attention for the coverage set update.

The coverage set update unit 13 adds, as an element of the coverage set, an index for identifying the input part data to which the element determined to be greater than or equal to a predetermined condition is applied, among the elements (weight coefficients) of the object attention after normalization for updating the coverage set. In the example of FIG. 3, the coverage set update unit 13 adds, as an element of the coverage set, a position of input part data multiplied by an element larger than the threshold t_{cover} among the elements of the object attention normalized for updating the coverage set.

In the time step 1, the coverage set update unit 13 adds the position “1” of the input part data in which the element of the object attention is “1.00” to the element of the coverage set C. As a result, the coverage set update unit 13 updates the value of the coverage set C from the empty set φ to {1}.

In the time step 2, the attention before correction in the time step 2 is relevant to the object attention before correction by the attention correction unit 14. The attention after correction in the time step 1 is relevant to the attention for generating the part that has already been generated among the parts of the output data. The similarity determination unit 12 determines whether the attention before correction in the time step 2 is similar to the attention after correction in the time step 1, and determines that there is no similar attention.

In this case, the attention correction unit 14 does not correct the object attention, and adopts the object attention calculated by the attention calculation unit 11 as it is as the corrected object attention. The attention generation device 10 outputs the object attention calculated by the attention calculation unit 11 as it is as the attention for generating the part of the output data by the data generation device.

In the time step 2, the maximum value of the element of corrected the object attention is 0.84. Therefore, the attention correction unit 14 calculates the coefficient for generating the object attention for the coverage set update as 1/0.84=1.19. The attention correction unit 14 multiplies each element of the corrected object attention by the calculated coefficient 1.19 to generate the object attention for the coverage set update.

The coverage set update unit 13 adds the position “2” of the input part data in which the element of the object attention is “1.00” to the element of the coverage set C. Accordingly, the coverage set update unit 13 updates the value of coverage set C from {1} to {1,2}.

In the time step 3, the attention before correction in the time step 3 is relevant to the object attention before correction by the attention correction unit 14. The attention after correction in each of the time steps 1 and 2 is relevant to the attention for generating the part that has already been generated among the parts of the output data. The similarity determination unit 12 determines whether the attention before correction in the time step 3 is similar to at least one of the attention after correction in the time steps 1 and 2, and determines that there is no similar attention.

In this case, the attention correction unit 14 does not correct the object attention, and adopts the object attention calculated by the attention calculation unit 11 as it is as the corrected object attention. The attention generation device 10 outputs the object attention calculated by the attention calculation unit 11 as it is as the attention for generating the part of the output data by the data generation device.

In the time step 3, the maximum value of the element of the corrected object attention is 0.52. Therefore, the attention correction unit 14 calculates the coefficient for generating the object attention for the coverage set update as 1/0.52=1.92. The attention correction unit 14 multiplies each element of the corrected object attention by the calculated coefficient 1.92 to generate the object attention for the coverage set update.

The coverage set update unit 13 adds the position “3” of the input part data in which the element of the object attention is “1.00” and the position “4” of the input part data in which the element of the attention is “0.85” to the elements of the coverage set C. Accordingly, the coverage set update unit 13 updates the value of coverage set C from {1, 2} to {1, 2,3,4}.

In a case where a plurality of elements among the elements of the object attention are set to be relatively large as in the object attention after correction in the time step 3, it is conceivable that the individual element becomes smaller than the threshold t_{cover} due to the constraint that the sum of the elements of the attention is 1. On the other hand, it can be understood that the data generation device generates the part of the output data by focusing on a part multiplied by a relatively large weight coefficient (element of attention) among the parts of the input data.

As described above, if the corrected object attention is used as it is for updating the coverage set C, it is conceivable that a coverage set that reduces the value of the weight coefficient applied to the input part data that has attracted attention (lowers the attention degree) cannot be obtained. Since the value of the weight coefficient added to the input part data that has attracted attention cannot be reduced, the data generation device cannot avoid or reduce erroneous processing of repeatedly generating the same portion data as the part of the output data by repeatedly paying attention to the same portion of the part of the input data.

On the other hand, the attention correction unit 14 generates the object attention for updating the coverage set by performing normalization for updating the coverage set.

As a result, even in a case where a plurality of weight coefficients among the weight coefficients included in the object attention are set to be relatively large, the coverage set update unit 13 can update the coverage set so as to reduce the value of the weight coefficient applied to the input part data that has attracted attention. By reducing the value of the weight coefficient attached to the input part data that has attracted attention, it is expected that the data generation device repeatedly focuses on the same portion of the part of the input data and avoids or reduces erroneous processing of repeatedly generating the same portion data as the part of the output data.

In the time step 4, the attention before correction in the time step 4 is relevant to the object attention before correction by the attention correction unit 14. The attention after correction in each of the time steps 1, 2, and 3 is relevant to the attention for generating the part that has already been generated among the parts of the output data.

Among the attentions after the correction, the attention after correction in the time step 2 is similar to the attention before correction in the time step 4. That is, these two attentions satisfy the determination criterion that the correlation coefficient is larger than 0.8.

The similarity determination unit 12 determines whether the attention before correction in the time step 4 is similar to at least one of the attention after correction in the time steps 1, 2 and 3, and determines that there is a similar attention.

In accordance with the determination result, the attention correction unit 14 rewrites the value of the element associated with each of the indexes 1, 2, 3, and 4 indicated in the coverage set C to “0.00” among the elements of the object attention before correction.

Then, the attention correction unit 14 performs normalization for setting the sum of the elements of the object attention to 1. In the case of the time step 4 in FIG. 3, the elements of the object attention before normalization for setting the sum of the elements of the object attention to 1 are “0.00”, “0.00”, “0.00”, “0.00”, and “0.12”. The attention correction unit 14 divides the sum of 0.12 of these elements from 1 to calculate a coefficient for setting the sum of the elements of the object attention to 1 as 1/0.12=8.33. The attention correction unit 14 multiplies each element of the object attention after the element is rewritten based on the coverage set by the calculated coefficient 8.33 to generate the corrected object attention. The attention generation device 10 outputs the corrected object attention generated by the attention correction unit 14 as attention for generating a part of the output data by the data generation device.

In the time step 4, the maximum value of the element of corrected the object attention is 1.00. Therefore, the attention correction unit 14 calculates the coefficient for generating the object attention for the coverage set update as 1/1.00=1.00. The attention correction unit 14 multiplies each element of the corrected object attention by the calculated coefficient 1.00 to generate the object attention for the coverage set update.

The coverage set update unit 13 adds the position “5” of the input part data in which the element of the object attention is “1.00” to the element of the coverage set C. Accordingly, the coverage set update unit 13 updates the value of coverage set C from {1, 2, 3, 4} to {1, 2, 3, 4, 5}.

After the time step 4, the data generation device finishes generating the output data, and the attention generation device 10 also finishes generating the attention.

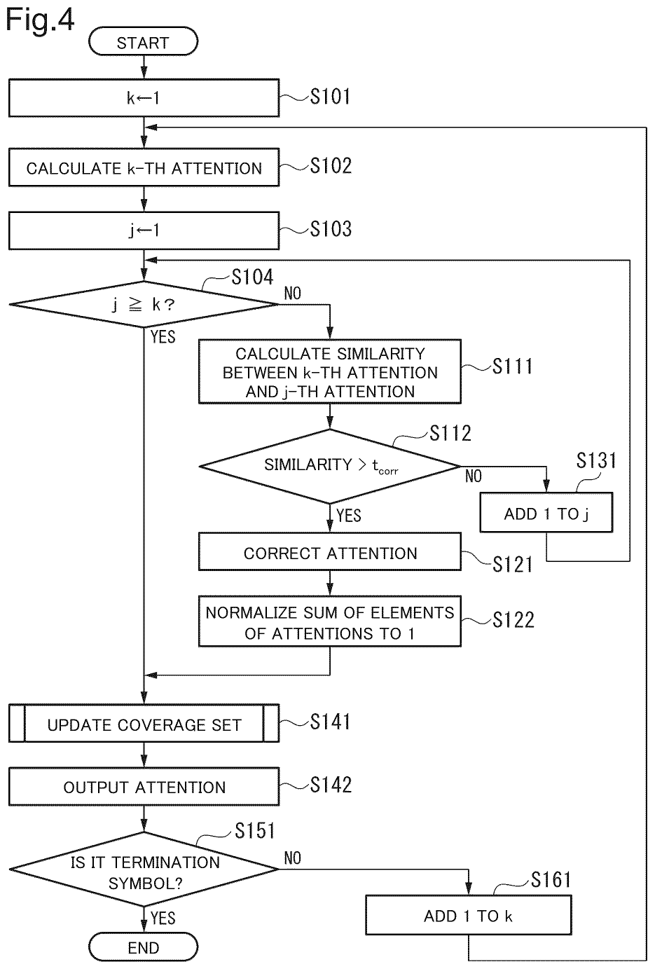

FIG. 4 is a diagram illustrating an example of a processing procedure in which the attention generation device 10 generates an attention.

In the processing of FIG. 4, the attention calculation unit 11 sets the value of a variable k indicating the identification number for identifying the object attention to 1 (step S101). The identification number for identifying the object attention indicated by the value of the variable k is relevant to the position of the output data in the example of FIG. 2.

Next, the attention calculation unit 11 calculates a k-th attention (step S102).

Next, the similarity determination unit 12 sets the value of a variable j indicating the identification number for identifying the attention for calculating the similarity with the object attention to 1 (step S103).

Then, the similarity determination unit 12 determines whether j≥k (step S104).

When determining that j<k is satisfied (step S104: NO), the similarity determination unit 12 calculates similarity between the k-th attention (object attention before correction) and the j-th attention (step S111).

The similarity determination unit 12 may calculate the similarity between the k-th attention and the j-th attention before correction. Alternatively, the similarity determination unit 12 may calculate the similarity between the k-th attention and the j-th attention after correction. In a case where the similarity determination unit 12 calculates the similarity between the k-th attention and the j-th attention after correction, in a case where the attention correction unit 14 has not corrected the j-th attention, the j-th attention (j-th attention before correction) calculated by the attention calculation unit 11 is treated as the j-th attention after correction.

Next, the similarity determination unit 12 determines whether the calculated similarity is larger than a threshold t_{corr} (step S112). When determining that the similarity is equal to or less than the threshold t_{corr} (step S112: NO), the similarity determination unit 12 adds 1 to the variable j (step S131). After step S131, the process returns to step S104.

On the other hand, in a case where it is determined in step S112 that the similarity is larger than the threshold t_{corr} (step S112: YES), the attention correction unit 14 corrects the object attention (step S121). Specifically, the attention correction unit 14 rewrites the value of the element associated with the index indicated in the coverage set C among the elements of the object attention to 0 or a value determined in advance as a sufficiently small positive value.

Next, the attention correction unit 14 normalizes the attention after correction in step S121 so that the sum of the elements becomes 1 (step S122).

Next, the coverage set update unit 13 updates the coverage set C (step S141).

The attention generation device 10 outputs the object attention (step S142). In a case where the attention correction unit 14 corrects the object attention, the attention generation device 10 outputs the corrected object attention. On the other hand, in a case where the attention correction unit 14 does not correct the object attention, the attention generation device 10 outputs the object attention calculated by the attention calculation unit 11.

Next, the attention generation device 10 determines whether the data generation device has output a termination symbol (step S151). That is, the attention generation device 10 determines whether the data generation device has completed the generation of the output data.

In a case where the attention generation device 10 determines that the data generation device has not output the termination symbol (step S151: NO), the attention calculation unit 11 adds 1 to the variable k (step S161).

After step S161, the process returns to step S102.

On the other hand, in step S104, in a case where the similarity determination unit 12 determines that j≥k (step S104: YES), the process proceeds to step S141.

In a case where it is determined in step S151 that the data generation device has output the termination symbol (step S151: YES), the attention generation device 10 ends the processing of FIG. 4.

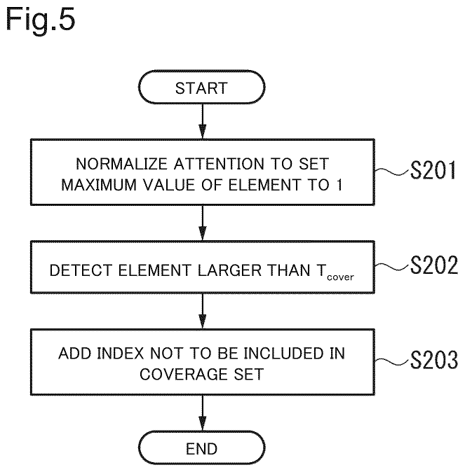

FIG. 5 is a diagram illustrating an example of a processing procedure in which the attention generation device 10 updates the coverage set. The attention generation device 10 performs the processing of FIG. 5 in step S141 of FIG. 4. In the processing of FIG. 5, the attention correction unit 14 performs normalization for updating the coverage set on the object attention (step S201). That is, the attention correction unit 14 detects the largest element among the elements of the object attention, calculates a coefficient by which the detected element becomes 1, and multiplies each element of the object attention by the calculated coefficient.

Next, the coverage set update unit 13 detects an element larger than the threshold t_{cover} among the elements of the object attention after normalization (step S202).

Then, the coverage set update unit 13 adds an index not included in the coverage set C among the indexes of the elements detected in step S202 to the coverage set C (step S203).

After step S203, the attention generation device 10 ends the processing of FIG. 5.

As described above, the attention calculation unit 11 calculates the attention for each part of the output data for generating the part of the output data. The attention is a weight coefficient for each part of the input data.

The attention correction unit 14 corrects the object attention based on the attention for generating the part that has already been generated among the parts of the output data. The object attention is an attention for generating a part to be generated among the parts of the output data.

According to the attention generation device 10, when the object attention is generated, it is possible to reflect the weighting status for each part of the input data by the attention for generating the part that has already been generated among the parts of the output data. According to the attention generation device 10, in this respect, in the data processing, in a case where the part of the data to be processed is weighted, repetition of the part of the data is expected to be avoided or reduced in the data obtained by the data processing.

The coverage set update unit 13 adds, as an element of the coverage set, an index for identifying the part of the input data to which the weight coefficient determined to be larger than or equal to a predetermined condition among the weight coefficients included in the object attention is applied. The coverage set is a set having an index for identifying a part of the input data as an element.

The attention correction unit 14 rewrites the value of the weight coefficient associated with the index indicated in the coverage set before the information regarding the object attention is reflected among the weight coefficients included in the object attention to 0 or a value determined in advance as a sufficiently small positive value.

The attention generation device 10 can store, in the coverage set, the part of the input data that has attracted attention at the time of generating the part that has already been generated among the parts of the output data. In this point, the attention generation device 10 can relatively easily correct the object attention.

The attention correction unit 14 generates an object attention for coverage set update in which a coefficient with which the maximum weight coefficient among the weight coefficients included in the object attention becomes a predetermined value is multiplied by each weight coefficient of the object attention. Using the object attention for the coverage set update, the coverage set update unit 13 adds, as an element of the coverage set, an index for identifying a part of the input data to which a weight coefficient having a value larger than a predetermined threshold after multiplication of the factor is applied.

Even in a case where a plurality of elements among the elements of the attention are set to be relatively large, the coverage set update unit 13 can update the coverage set so as to reduce the value of the weight coefficient applied to the input part data that has attracted attention. By reducing the value of the weight coefficient attached to the input part data that has attracted attention, it is expected that the data generation device repeatedly focuses on the same portion of the part of the input data and avoids or reduces erroneous processing of repeatedly generating the same portion data as the part of the output data.

The similarity determination unit 12 calculates the similarity between each of the generated attention for generating the part of the output data and the object attention.

Then, the similarity determination unit 12 determines the presence or absence of an attention similar to the object attention among the attentions for generating the part that has already been generated among the parts of the output data. In a case where the similarity determination unit 12 determines that there is an attention similar to the object attention among the attentions for generating the part that has already been generated among the parts of the output data, the attention correction unit 14 corrects the object attention based on the attention for generating the part that has already been generated among the parts of the output data.

The attention generation device 10 corrects the object attention only in a case where it is determined that the object attention is similar to the attention previously generated. In this point, there are relatively few object attention corrections for avoiding or reducing repetition of the part of the data. According to the attention generation device 10, in this point, a part of the output data is relatively often generated using the object attention calculated by the attention calculation unit 11, and it is expected that the output data can be generated with relatively high accuracy.

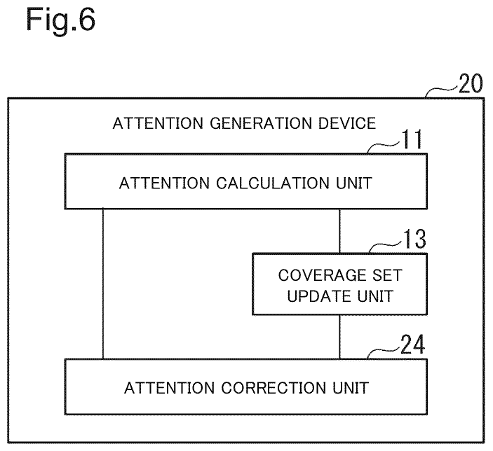

FIG. 6 is a diagram illustrating an example of a configuration of an attention generation device according to some example embodiments of the present disclosure. In the configuration illustrated in FIG. 6, an attention generation device 20 includes an attention calculation unit 11, a coverage set update unit 13, and an attention correction unit 24.

In the units of FIG. 6, the units having similar functions to those of the parts of FIG. 1 are denoted by the same reference numerals (11, 13), and a detailed description thereof will be omitted here.

The attention generation device 20 is different from the attention generation device 10 in that the similarity determination unit 12 is not provided. Accordingly, the processing performed by the attention correction unit 24 of the attention generation device 20 is different from the processing performed by the attention correction unit 14 of the attention generation device 10. Otherwise, the attention generation device 20 is similar to the attention generation device 10.

The attention correction unit 24 differs from the attention correction unit 14 in the element to be corrected among the elements of the object attention. The attention correction unit 24 corrects the object attention based on the coverage set C every time the attention calculation unit 11 calculates the object attention. However, in a case where the coverage set C is the empty set φ, the attention correction unit 24 does not correct the object attention.

The method by which the attention correction unit 24 corrects the element of the object attention is similar to the case of the attention correction unit 14. The attention correction unit 24 rewrites the value of the element associated with the index indicated in the coverage set before the information regarding the object attention is reflected among the elements (weight coefficients) of the object attention to 0 or a value determined in advance as a sufficiently small positive value.

The normalization performed by the attention correction unit 24 to set the sum of the elements of the object attention to 1 is similar to the case of the attention correction unit 14. The attention correction unit 24 calculates the sum of the elements of the object attention object attention corrected based on the coverage set. Then, the attention correction unit 24 calculates the reciprocal of the calculated sum as a coefficient for setting the sum of each element of the object attention to 1. The attention correction unit 24 multiplies each element of the object attention after the element is rewritten based on the coverage set by the calculated coefficient to generate the corrected object attention.

The processing in which the attention correction unit 24 generates the object attention for the coverage set update is also similar to the case of the attention correction unit 14. The attention correction unit 24 detects the largest element among the elements of the object attention after correction. Then, the attention correction unit 24 calculates the reciprocal of the detected maximum element as a coefficient for generating the object attention for the coverage set update. The attention correction unit 24 multiplies each element of the corrected object attention by the calculated coefficient to generate the object attention for the coverage set update.

The coverage set update unit 13 adds, as an element of the coverage set, an index for identifying the input part data to which the element determined to be greater than or equal to a predetermined condition among the elements of the object attention for the coverage set update is applied.

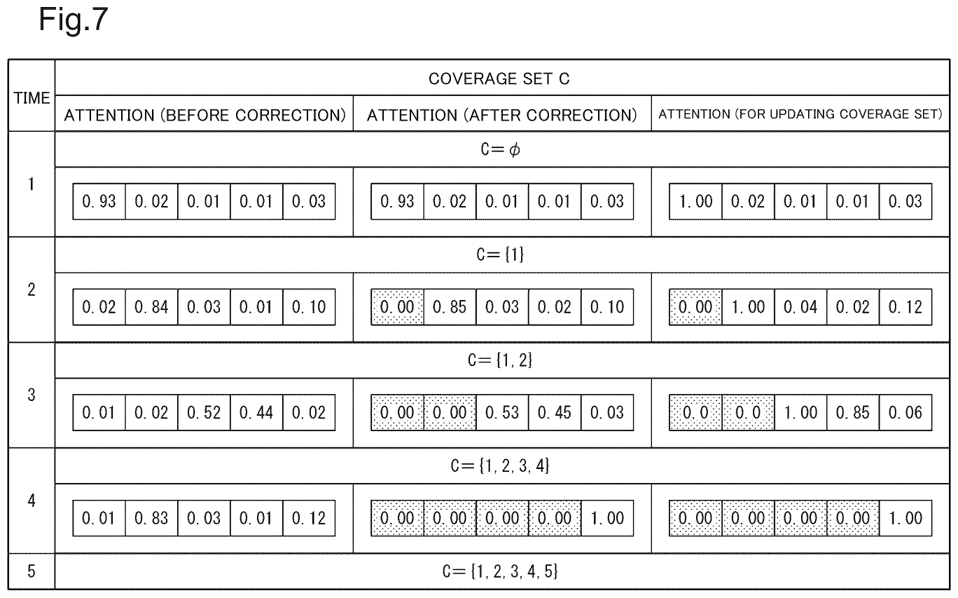

FIG. 7 is a diagram illustrating an example of attention correction by the attention correction unit 24. FIG. 7 illustrates an example of a case where the attention correction unit 24 corrects the attention in the example of FIG. 2.

FIG. 7 illustrates, for each time step, the coverage set before update in the time step, the attention before correction by the attention correction unit 24, the attention after correction by the attention correction unit 24, and the attention for updating the coverage set.

In FIG. 7, the time for the attention generation device 20 to generate the attention for generating one piece of output part data is set as one step of the time step.

The attention before correction is the attention calculated by the attention calculation unit 11, and the attention of the positions 1, 2, 3, and 4 of the output data in the example of FIG. 2 is illustrated in the order of time steps 1, 2, 3, and 4.

FIG. 7 illustrates an example of a case where the data generation device ends the generation of the output data after generating the part of the output data in the time step 4. Therefore, in the time step 5, the attention generation device 20 does not generate an attention.

Similarly to the case of FIG. 3, the initial value of the coverage set C is set to the empty set φ.

The attention correction unit 24 rewrites the value of the weight coefficient associated with the index indicated in the coverage set before the information regarding the object attention is reflected among the weight coefficients included in the object attention to 0 or a value determined in advance as a sufficiently small positive value.

In the time step 1, the value of the coverage set C is set to the empty set o which is an initial value. In this case, the attention correction unit 24 does not correct the object attention, and adopts the object attention calculated by the attention calculation unit 11 as it is as the corrected attention. The attention generation device 20 outputs the object attention calculated by the attention calculation unit 11 as it is as the attention for generating the part of the output data by the data generation device.

The attention correction unit 24 further generates an object attention for updating the coverage set. The attention correction unit 24 detects the largest element among the elements (weight coefficients) of the object attention after correction. Then, the attention correction unit 24 calculates a coefficient such that the value of the detected largest element becomes 1, and multiplies each element of the corrected object attention by the calculated coefficient. Alternatively, instead of the attention correction unit 24, the coverage set update unit 13 may generate the object attention for the coverage set update.

In the time step 1, the maximum value of the element of corrected the object attention is 0.93. Therefore, the attention correction unit 24 calculates the coefficient for generating the attention for the coverage set update as 1/0.93=1.08. The attention correction unit 24 multiplies each element of the corrected object attention by the calculated coefficient 1.08 to generate the object attention for the coverage set update.

The coverage set update unit 13 adds, as an element of the coverage set, an index for identifying the input part data to which the element determined to be greater than or equal to a predetermined condition is applied, among the elements (weight coefficients) included in the object attention after normalization for updating the coverage set.

In the example of FIG. 3, the coverage set update unit 13 adds, as an element of the coverage set, a position of input part data multiplied by an element larger than the threshold t_{cover} among the elements of the object attention normalized for updating the coverage set.

In the time step 1, the coverage set update unit 13 adds the position “1” of the input part data in which the element of the attention is “1.00” to the element of the coverage set C. As a result, the coverage set update unit 13 updates the value of the coverage set C from the empty set φ to {1}.

In the time step 2, the attention correction unit 24 rewrites the value of the first element indicated by the coverage set C among the elements of the object attention (object attention before correction) calculated by the attention calculation unit 11 to “0.00”. Then, the attention correction unit 24 performs normalization for setting the sum of the elements of the attention to 1 with respect to the object attention corrected based on the coverage set C, and generates the corrected object attention.

The attention generation device 20 outputs the corrected object attention generated by the attention correction unit 24 as an attention for generating a part of the output data by the data generation device.

In the time step 2, the maximum value of the element of corrected the object attention is 0.85. Therefore, the attention correction unit 24 calculates the coefficient for generating the object attention for the coverage set update as 1/0.85=1.18. The attention correction unit 24 multiplies each element of the corrected object attention by the calculated coefficient 1.19 to generate the object attention for the coverage set update.

The coverage set update unit 13 adds the position “2” of the input part data in which the element of the object attention is “1.00” to the element of the coverage set C. Accordingly, the coverage set update unit 13 updates the value of coverage set C from {1} to {1,2}.

In the time step 3, the attention correction unit 24 rewrites the value of the first element and the value of the second element indicated by the coverage set C among the elements of the object attention (object attention before correction) calculated by the attention calculation unit 11 to “0.00”. Then, the attention correction unit 24 performs normalization for setting the sum of the elements of the attention to 1 with respect to the object attention corrected based on the coverage set C, and generates the corrected object attention. The attention generation device 20 outputs the corrected object attention generated by the attention correction unit 24 as an attention for generating a part of the output data by the data generation device.

In the time step 3, the maximum value of the element of corrected the object attention is 0.53. Therefore, the attention correction unit 24 calculates the coefficient for generating the object attention for the coverage set update as 1/0.53=1.89. The attention correction unit 24 multiplies each element of the corrected object attention by the calculated coefficient 1.89 to generate the object attention for the coverage set update.

The coverage set update unit 13 adds the position “3” of the input part data in which the element of the object attention is “1.00” and the position “4” of the input part data in which the element of the attention is “0.85” to the elements of the coverage set C. Accordingly, the coverage set update unit 13 updates the value of coverage set C from {1, 2} to {1, 2, 3,4}.

In the time step 4, the attention correction unit 24 rewrites the value of each of the first, second, third, and fourth elements indicated by the coverage set C among the elements of the object attention (object attention before correction) calculated by the attention calculation unit 11 to “0.00”. Then, the attention correction unit 24 performs normalization for setting the sum of the elements of the attention to 1 with respect to the object attention corrected based on the coverage set C, and generates the corrected object attention. The attention generation device 20 outputs the corrected object attention generated by the attention correction unit 24 as an attention for generating a part of the output data by the data generation device.

In the time step 4, the maximum value of the element of corrected the object attention is 1.00. Therefore, the attention correction unit 24 calculates the coefficient for generating the object attention for the coverage set update as 1/1.00=1.00. The attention correction unit 24 multiplies each element of the corrected object attention by the calculated coefficient 1.00 to generate the object attention for the coverage set update.

The coverage set update unit 13 adds the position “5” of the input part data in which the element of the object attention is “1.00” to the element of the coverage set C. Accordingly, the coverage set update unit 13 updates the value of coverage set C from {1, 2, 3, 4} to {1, 2, 3, 4, 5}.

After the time step 4, the data generation device finishes generating the output data, and the attention generation device 20 also finishes generating the attention.

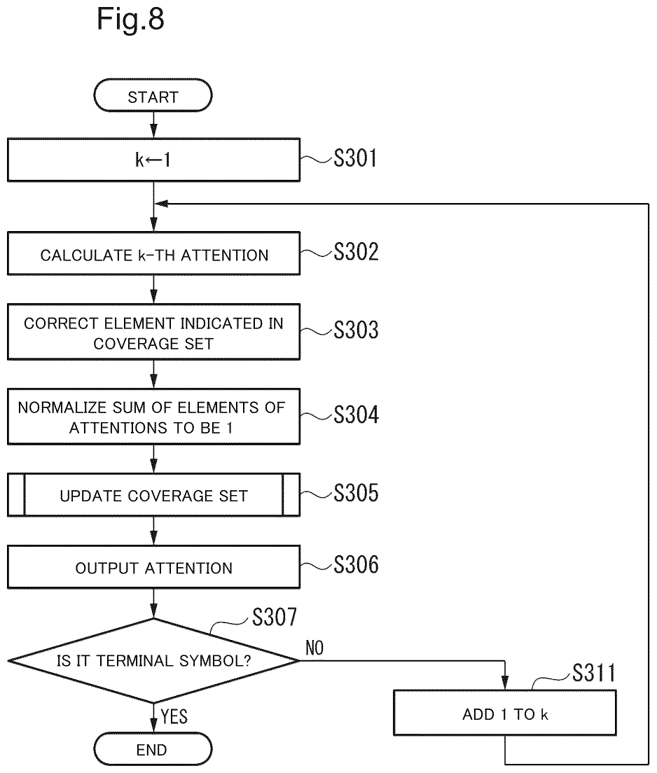

FIG. 8 is a diagram illustrating an example of a processing procedure in which the attention generation device 20 generates an attention.

Steps S301 and S302 in FIG. 8 are similar to steps S101 and S102 in FIG. 4.

After step S302, the attention correction unit 24 rewrites the element indicated in the coverage set among the elements of the k-th attention calculated by the attention calculation unit 11 in step S302 to 0 or a value determined in advance as a sufficiently small positive value (step S303).

Next, the attention correction unit 24 normalizes the attention after correction in step S302 so that the sum of the elements becomes 1 (step S304).

Next, the coverage set update unit 13 updates the coverage set C (step S305). In step S305, the coverage set update unit 13 performs the processing of FIG. 5.

The attention generation device 20 outputs the object attention (step S306). In a case where the attention correction unit 24 corrects the object attention, the attention generation device 20 outputs the corrected object attention. On the other hand, in a case where the attention correction unit 24 does not correct the object attention, the attention generation device 20 outputs the object attention calculated by the attention calculation unit 11.

Next, the attention generation device 20 determines whether the data generation device has output a termination symbol (step S307). That is, the attention generation device 20 determines whether the data generation device has completed the generation of the output data.

In a case where the attention generation device 20 determines that the data generation device has not output the termination symbol (step S307: NO), the attention calculation unit 11 adds 1 to the variable k (step S311).

After step S311, the process returns to step S302.

On the other hand, in a case where it is determined in step S307 that the data generation device has output the termination symbol (step S307: YES), the attention generation device 20 ends the processing of FIG. 8.

The attention generation device 20 is expected to require a relatively short time to generate an attention in that it is not necessary to calculate the similarity of the attention.

An example of the attention generation device 10 or a data generation device using the attention generation device 20 will be described as a description of some example embodiments of the present disclosure.

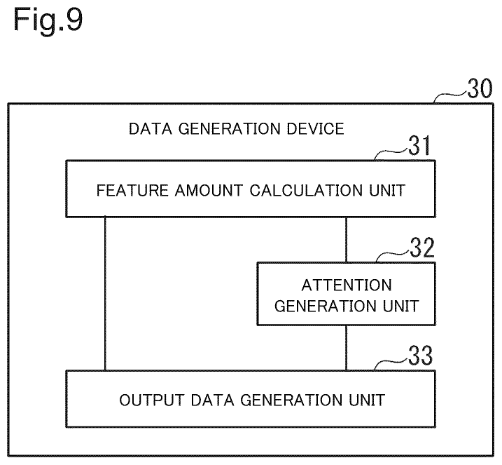

FIG. 9 is a diagram illustrating an example of a configuration of a data generation device according to some example embodiments of the present disclosure. In the configuration illustrated in FIG. 9, a data generation device 30 includes a feature amount calculation unit 31, an attention generation unit 32, and an output data generation unit 33.

The data generation device 30 converts input data into output data using the attention. The voice recognition device, the machine translation device, the character recognition device, and the image recognition device described above are relevant to examples of the data generation device 30. However, the data generation device 30 is not limited thereto.

The feature amount calculation unit 31 calculates a feature amount of the part for each part of the input data.

The attention generation unit 32 generates an attention. Either the attention generation device 10 or the attention generation device 20 is relevant to an example of the attention generation unit 32. The attention generation unit 32 may be configured outside the data generation device 30.

The output data generation unit 33 generates output data for each unit based on the feature amount calculated by the feature amount calculation unit 31 and the attention generated by the attention generation unit 32.

The data generation device 30 may be configured using a neural network. For example, each of the feature amount calculation unit 31 and the output data generation unit 33 may be configured using a neural network.

Alternatively, the combination of the feature amount calculation unit 31 and the output data generation unit 33 may be configured using one neural network. In this case, the attention generation unit 32 can be regarded as converting the internal data of the neural network.

The data generation device 30 may grasp an instruction by a user's voice by voice recognition and natural language processing, and may be used for a smart speaker that executes the instruction. For example, the data generation device 30 may be configured as a part of a smart speaker, and may perform voice recognition and natural language processing, or any of these.

The data generation device 30 may be used for a smartphone having a voice assistant function (AI assistant function) that recognizes an instruction by the user's voice by voice recognition and natural language processing and executes the instruction. For example, the data generation device 30 may be configured as a part of a smartphone, and may perform voice recognition and natural language processing, or any of these.

The data generation device 30 may be used in a sentence analysis system that receives an input of a sentence in a natural language by voice input or character string input and analyzes the input sentence. For example, the data generation device 30 may be configured as a part of the sentence analysis system, and may perform any one or more of speech recognition, natural language processing, and sentence analysis.

The data generation device 30 may be used in an image retrieval system that accepts a user's instruction in a natural language by voice input or character string input and retrieves an image. For example, the data generation device 30 may be configured as a part of the image retrieval system, and may perform voice recognition, natural language processing, generation of an explanatory sentence of an image of a retrieval result, or any one or more of these.

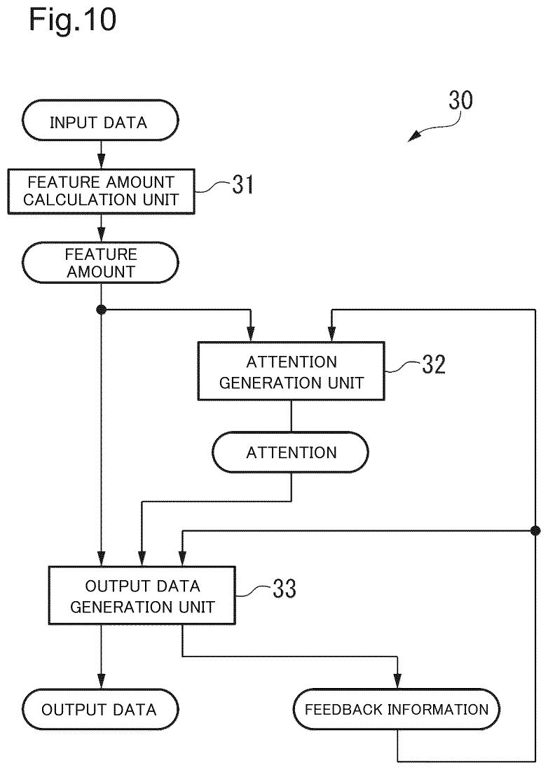

FIG. 10 is a diagram illustrating an example of input and output of data in each unit of the data generation device 30. The feature amount calculation unit 31 calculates a feature amount of each part of the input data to the data generation device 30.

The attention generation unit 32 generates an attention based on the feature amount for each part of the input data calculated by the feature amount calculation unit 31 and feedback information indicating a status of generation of the part of the output data by the output data generation unit 33.

The output data generation unit 33 generates output data for each part based on the feature amount for each part of the input data calculated by the feature amount calculation unit 31, the attention generated by the attention generation unit 32, and feedback information indicating a status of generation of the part of the output data by the output data generation unit 33 itself.

According to the data generation device 30, it is expected that repetition of the part of the data can be avoided or reduced in the output data.

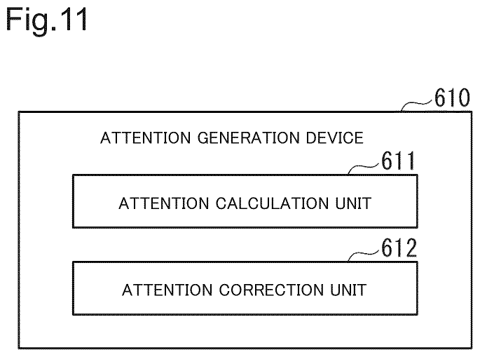

FIG. 11 is a diagram illustrating an example of a configuration of an attention generation device according to some example embodiments of the present disclosure. In the configuration illustrated in FIG. 11, an attention generation device 610 includes an attention calculation unit 611, and an attention correction unit 612.

With this configuration, the attention calculation unit 611 calculates the attention for each part of the output data for generating the part of the output data. The attention is a weight coefficient for each part of the input data.

The attention correction unit 612 corrects the object attention based on the attention for generating the part that has already been generated among the parts of the output data. The object attention is an attention for generating a part to be generated among the parts of the output data.

The attention calculation unit 611 is relevant to an example of an attention calculation means. The attention correction unit 612 is relevant to an example of an attention correction means.

According to the attention generation device 610, when the object attention is generated, it is possible to reflect the weighting status for each part of the input data by the attention for generating the part that has already been generated among the parts of the output data. According to the attention generation device 610, in this respect, in the data processing, in a case where the part of the data to be processed is weighted, repetition of the part of the data is expected to be avoided or reduced in the data obtained by the data processing.

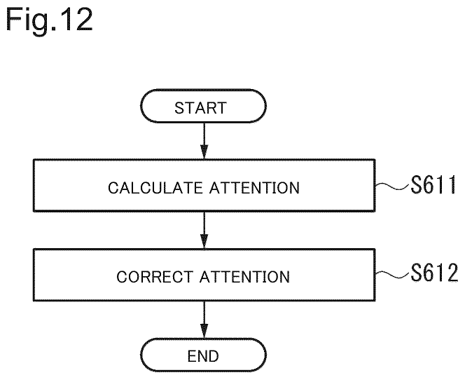

FIG. 12 is a diagram illustrating an example of a processing procedure in an attention generation method according to some example embodiments of the present disclosure. The attention generation method illustrated in FIG. 12 includes calculating attention (step S611) and correcting the attention (step S612).

In calculating the attention (step S611), the computer calculates the attention for each part of the output data for generating the part of the output data. The attention is a weight coefficient for each part of the input data.

In correcting the attention (step S612), the computer corrects the object attention based on the attention for generating the part that has already been generated among the parts of the output data. The object attention is an attention for generating a part to be generated among the parts of the output data.

According to the attention generation method illustrated in FIG. 12, when the object attention is generated, it is possible to reflect the weighting status for each part of the input data by the attention for generating the part that has already been generated among the parts of the output data. According to the attention generation method illustrated in FIG. 12, in this respect, in the data processing, in a case where the part of the data to be processed is weighted, repetition of the part of the data is expected to be avoided or reduced in the data obtained by the data processing.

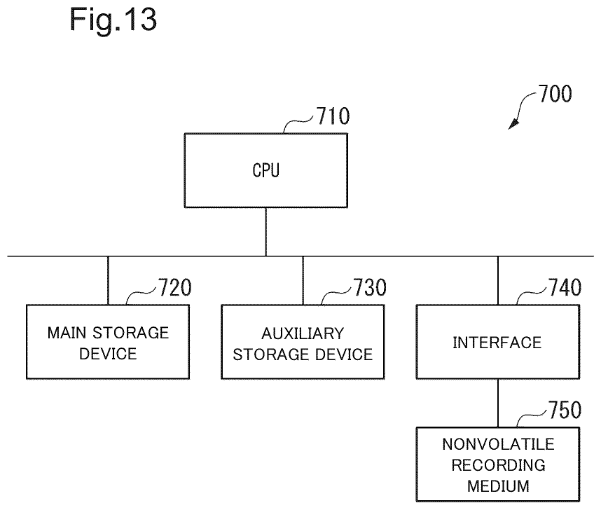

FIG. 13 is a schematic block diagram illustrating a configuration of a computer according to at least one example embodiment.

In the configuration illustrated in FIG. 13, a computer 700 includes a CPU 710, a main storage device 720, an auxiliary storage device 730, an interface 740, and a nonvolatile recording medium 750.

Any one or more of the attention generation device 10, the attention generation device 20, the data generation device 30, and the attention generation device 610 described above, or a part thereof, may be implemented in the computer 700. In that case, the operation of each processing unit described above is stored in the auxiliary storage device 730 in the form of a program. The CPU 710 reads the program from the auxiliary storage device 730, develops the program in the main storage device 720, and executes the above processing according to the program.

The CPU 710 secures a storage area relevant to each of the above-described storage units in the main storage device 720 according to the program. Communication between each device and another device is executed by the interface 740 having a communication function and performing communication under the control of the CPU 710.

In a case where the attention generation device 10 is implemented in the computer 700, the operation of the attention generation device 10 and each unit thereof is stored in the auxiliary storage device 730 in the form of a program. The CPU 710 reads the program from the auxiliary storage device 730, develops the program in the main storage device 720, and executes the above processing according to the program.

The CPU 710 secures a storage area for the attention generation device 10 to perform processing in the main storage device 720 according to the program. The communication between the attention generation device 10 and another device is executed by the interface 740 having a communication function and operating under the control of the CPU 710. The interaction between the attention generation device 10 and the user is executed by a user's operation on various images displayed in a display device with an input device, which are included in the interface 740, under the control of the CPU 710.

In a case where the attention generation device 20 is implemented in the computer 700, the operation of the attention generation device 20 and each unit thereof is stored in the auxiliary storage device 730 in the form of a program. The CPU 710 reads the program from the auxiliary storage device 730, develops the program in the main storage device 720, and executes the above processing according to the program.

The CPU 710 secures a storage area for the attention generation device 20 to perform processing in the main storage device 720 according to the program. The communication between the attention generation device 20 and another device is executed by the interface 740 having a communication function and operating under the control of the CPU 710. The interaction between the attention generation device 20 and the user is executed by a user's operation on various images displayed in a display device with an input device, which are included in the interface 740, under the control of the CPU 710.

In a case where the data generation device 30 is implemented in the computer 700, the operation of the data generation device 30 and each unit thereof is stored in the auxiliary storage device 730 in the form of a program. The CPU 710 reads the program from the auxiliary storage device 730, develops the program in the main storage device 720, and executes the above processing according to the program.

The CPU 710 secures a storage area for the data generation device 30 to perform processing in the main storage device 720 according to the program. The communication between the data generation device 30 and another device is executed by the interface 740 having a communication function and operating under the control of the CPU 710. The interaction between the data generation device 30 and the user is executed by a user's operation on various images displayed in a display device with an input device, which are included in the interface 740, under the control of the CPU 710.

In a case where the attention generation device 610 is implemented in the computer 700, the operation of the attention generation device 610 and each unit thereof is stored in the auxiliary storage device 730 in the form of a program. The CPU 710 reads the program from the auxiliary storage device 730, develops the program in the main storage device 720, and executes the above processing according to the program.

The CPU 710 secures a storage area for the attention generation device 610 to perform processing in the main storage device 720 according to the program. The communication between the attention generation device 610 and another device is executed by the interface 740 having a communication function and operating under the control of the CPU 710. The interaction between the attention generation device 610 and the user is executed by a user's operation on various images displayed in a display device with an input device, which are included in the interface 740, under the control of the CPU 710.

A program for executing all or part of the processing performed by the attention generation device 10, the attention generation device 20, the data generation device 30, and the attention generation device 610 may be recorded in a computer-readable recording medium, and the computer system may read and execute the program recorded in the recording medium to perform the processing of each unit. The “computer system” here includes hardware such as an OS and peripheral devices.

The “computer-readable recording medium” refers to a portable medium such as a flexible disk, a magneto-optical disk, a read only memory (ROM), and a compact disc read only memory (CD-ROM), and a storage device such as a hard disk built in a computer system. The program may be for achieving a part of the functions described above, and the functions described above may be achieved in combination with a program already recorded in the computer system.

Although the example embodiments of the present invention have been described in detail with reference to the drawings, the specific configuration is not limited to the example embodiments, and includes design and the like within a range not departing from the gist of the present invention.

Some or all of the above-described example embodiments may be described as the following Supplementary Notes, but are not limited to the following Supplementary Notes.

### Supplementary Note 1

An attention generation device including:
an attention calculation means that calculates an attention, which is a weight coefficient for each part of input data, for generating a part of output data for each part of the output data; and
an attention correction means that corrects an object attention, which is an attention for generating a part to be generated among the parts of the output data, based on an attention for generating a part that has already been generated among the parts of the output data.

### Supplementary Note 2

The attention generation device according to Supplementary Note 1, further including:
a coverage set update means that adds an index for identifying a part of the input data to which a weight coefficient determined to be larger than or equal to a predetermined condition among weight coefficients included in the object attention is applied, as an element of a coverage set that is a set including the index for identifying the part of the input data as an element,
in which the attention correction means rewrites a value of a weight coefficient associated with an index indicated in the coverage set before information regarding the object attention is reflected among weight coefficients included in the object attention to 0 or a value determined in advance as a sufficiently small positive value.

### Supplementary Note 3

The attention generation device according to Supplementary Note 2, in which
the coverage set update means adds, as an element of the coverage set, an index for identifying a part of the input data to which a weight coefficient whose value after multiplication by a coefficient is larger than a predetermined threshold is applied, by using an object attention in which a coefficient with which a maximum weight coefficient among weight coefficients included in the object attention becomes a predetermined value is multiplied by each weight coefficient of the object attention.

### Supplementary Note 4

The attention generation device according to any one of Supplementary Notes 1 to 3, further including:
a similarity determination means that calculates similarity between each of attentions for generating a part that has already been generated among parts of the output data and the object attention and determining presence or absence of an attention similar to the object attention among the attentions for generating a part that has already been generated among the parts of the output data,
in which, in a case where the similarity determination means determines that there is an attention similar to the object attention among the attentions for generating a part that has already been generated among the parts of the output data, the attention correction means corrects the object attention based on an attention for generating a part that has already been generated among the parts of the output data.

### Supplementary Note 5

An attention generation method for causing a computer to execute:
calculating an attention, which is a weight coefficient for each part of input data, for generating a part of output data for each part of the output data; and
correcting an object attention, which is an attention for generating a part to be generated among the parts of the output data, based on an attention for generating a part that has already been generated among the parts of the output data.

### Supplementary Note 6

A recording medium storing a program for causing the computer to execute:
calculating an attention, which is a weight coefficient for each part of input data, for generating a part of output data for each part of the output data; and
correcting an object attention, which is an attention for generating a part to be generated among the parts of the output data, based on an attention for generating a part that has already been generated among the parts of the output data.

This application claims priority based on Japanese Patent Application No. 2023-001310 filed on Jan. 6, 2023, the entire disclosure of which is incorporated herein.

### INDUSTRIAL APPLICABILITY

The present disclosure may be applied to an attention generation device, an attention generation method, and a recording medium.

### REFERENCE SIGNS LIST

10, 20,610 attention generation device
11, 611 attention calculation unit
12 similarity determination unit
13 coverage set update unit
14, 24, 612 attention correction unit
30 data generation device
31 feature amount calculation unit
32 attention generation unit
33 output data generation unit

What is claimed is:

1. An attention generation device comprising:
a memory storing instructions; and
a processor connected to the memory and configured to execute the instructions to:
calculate an attention, which is a weight coefficient for each part of input data, for generating a part of output data for each part of the output data; and
correct an object attention, which is an attention for generating a part to be generated among the parts of the output data, based on an attention for generating a part that has already been generated among the parts of the output data.

2. The attention generation device according to claim 1, wherein
the processor is configured to execute the instructions to
add an index for identifying a part of the input data to which a weight coefficient determined to be larger than or equal to a predetermined condition among weight coefficients included in the object attention is applied, as an element of a coverage set that is a set including the index for identifying the part of the input data as an element, and
rewrite a value of a weight coefficient associated with an index indicated in the coverage set before information regarding the object attention is reflected among weight coefficients included in the object attention to 0 or a value determined in advance as a sufficiently small positive value.

3. The attention generation device according to claim 2, wherein
the processor is configured to execute the instructions to
add, as an element of the coverage set, an index for identifying a part of the input data to which a weight coefficient whose value after multiplication by a coefficient is larger than a predetermined threshold is applied, by using an object attention in which a coefficient with which a maximum weight coefficient among weight coefficients included in the object attention becomes a predetermined value is multiplied by each weight coefficient of the object attention.

4. The attention generation device according to claim 1, wherein
the processor is configured to execute the instructions to
calculate similarity between each of attentions for generating a part that has already been generated among parts of the output data and the object attention and determining presence or absence of an attention similar to the object attention among the attentions for generating a part that has already been generated among the parts of the output data, and
in a case where determined to be an attention similar to the object attention among the attentions for generating a part that has already been generated among the parts of the output data, correct the object attention based on an attention for generating a part that has already been generated among the parts of the output data.

5. An attention generation method for causing a computer to execute:
calculating an attention, which is a weight coefficient for each part of input data, for generating a part of output data for each part of the output data; and
correcting an object attention, which is an attention for generating a part to be generated among the parts of the output data, based on an attention for generating a part that has already been generated among the parts of the output data.

6. A recording medium storing a program for causing the computer to execute:
calculating an attention, which is a weight coefficient for each part of input data, for generating a part of output data for each part of the output data; and
correcting an object attention, which is an attention for generating a part to be generated among the parts of the output data, based on an attention for generating a part that has already been generated among the parts of the output data.
